(19) United States
(12) Patent Application Publication
(10) Pub. No.: US 2010/0209204 A1
(43) Pub. Date: Aug. 19, 2010

(54) METHOD FOR FORMING AN INTERNAL THREAD ON A BASE BODY

(75) Inventors: Matthias WISSLING, St. Gallen (CH); Marc Schaeffer, Feldkirch-Nofels (AT)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/705,102

(22) Filed: Feb. 12, 2010

(30) Foreign Application Priority Data
Feb. 16, 2009 (DE) 10 2009 000 891.8

(51) Int. Cl. B23G 5/06; B23G 1/00

(52) U.S. Cl. 408/1 R; 470/18; 408/222; 470/198

(57) ABSTRACT

A method and apparatus for forming an internal thread on a base body is disclosed. A threading tool that features in parts at least one section having a thread-forming structure is inserted into an opening in the base body, and then, the entire internal thread is formed in the base body by a maximum rotation of the threading tool of 360°.

This application claims the priority of German Patent Document No. 10 2009 000 891.8, filed Feb. 16, 2009, the disclosure of which is expressly incorporated by reference herein.

### BACKGROUND AND SUMMARY OF THE INVENTION

The invention relates to a method for forming an internal thread on a base body. The invention relates further to a threading tool for executing the method.

Thread-cutting and thread-forming methods are known for forming an internal thread on a bush base body, for example, for producing a tapped bush or an internal thread in a component.

In the case of thread-cutting by machining, such as described in U.S. Pat. No. 5,993,120, a thread cutter, which has thread-cutting sections as well as at least one cutting edge, is inserted as a threading tool into a previously formed opening in the component and continuously rotated, wherein the internal thread is cut in the wall of the opening.

The disadvantage of the known attainment is that forming the internal thread is time-consuming and costly, because the thread cutter must move from the beginning to the end of the thread length.

A thread-forming method and a thread former as a threading tool are known from U.S. Pat. No. 5,607,005, in which forming the internal thread is carried out by non-machining. In the case of this method, the material in the region of the internal thread is reinforced.

The disadvantage of the known attainment is that forming the internal thread is time consuming and costly, because also in this case, the thread former must move from the beginning to the end of the thread length.

The object of the invention is creating a method and a threading tool for forming an internal thread on a base body, which makes a more economic manufacture of the internal thread possible.

According to the inventive method, to form an internal thread on a base body, first a threading tool that features in parts at least one section having a thread-forming structure is inserted into an opening in the base body and then the entire internal thread is formed in the base body by a maximum rotation of the threading tool of 360°.

The threading tool for forming the internal thread is driven into the opening in the base body directly until the end of the thread length being created. The opening is, for example, a borehole of an interior space of the base body delimited by a wall. The sections having the thread-forming structure are, for example, in plan view segments of a circle, whose center lies outside the longitudinal axis or the center of the shaft. The thread-forming structure is formed of several elements arranged parallel to each other and in succession in the axial direction of the shaft or of the insertion direction. Since the entire internal thread is created merely by a rotation of the inserted threading tool around an angular range, which is less than a full rotation of 360°, a significant reduction in the cycle time during thread production is possible as compared with previous methods. As a result, it is possible to produce tapped bushes, for example, in a much simpler and more economical manner.

If a very long internal thread has to be created, the threading tool is inserted into the opening with its entire axial length, rotated and then displaced further into the opening by the amount of its axial length and then rotated again, until the entire length of the internal thread has been achieved. As a result, it is possible to realize a decisive reduction in cycle time with the method according to the invention even in the case of long internal threads.

The threading tool preferably features several sections having a thread-forming structure arranged in a symmetry of rotation of an integral order and the threading tool is rotated around an angle of rotation, which corresponds to the value of the quotient of a full circle divided by the number of sections having the thread-forming structure of the threading tool. If the threading tool features, for example, three sections having thread-forming structure, the sections are spaced apart from one another in an angular range of 120° and the threading tool is rotated correspondingly by 120° to form the internal thread after insertion into the base body. If the threading tool features, for example, four sections having thread-forming structure, the angle of rotation of the threading tool for forming the internal thread is correspondingly 90°.

Preferably prior to the insertion of the threading tool, recesses arranged in the inner wall of the base body in a symmetry of rotation of an integral order are provided, the number of the recesses corresponding to the number of sections having the thread-forming structure on the threading tool and the design of the recesses being coordinated with the design of the sections having the thread-forming structure on the threading tool. During insertion of the threading tool, the sections having the thread-forming structure penetrate into these recesses in the base body. During the subsequent rotation of the threading tool, the material of the base body between the recesses is formed into the internal thread. The threads produced using this method are interrupted and therefore not continuous. The length of these interruptions can be reduced to a very short region by appropriately coordinating the design of the recesses in the base body with the design of the sections of the threading tool that feature the thread-forming structure.

The internal thread is preferably formed by machining in the base body, which makes an exact formation of the threads possible. The chips accumulating with this method are preferably removed by the supply of a fluid, such as, for example, a flushing liquid, during thread cutting.

Alternatively, the internal thread is formed by non-machining in the base body, wherein the material in the region of the created threads is reinforced, and therefore, the created internal thread features high load ratings. In addition, during thread grooving, no material loss of the base body accumulates as compared with thread cutting, whereby, for example, the core diameter of a bush-shaped base body can be designed to be greater than with an internal thread produced in a machining method or whereby base body material can be saved.

A threading tool, according to the invention for forming an internal thread on a base body, features a shaft, which has an outside diameter, and a thread-forming device arranged on the shaft. The thread-forming device features several circumferentially spaced-apart sections arranged in a symmetry of rotation of an integral order, which sections project beyond the outside diameter of the shaft and which feature thread-forming structure on their outer sides.

The thread-forming structure is provided along the axial length of the sections provided on the shaft and projecting on the outside diameter of the shaft. This threading tool may be used particularly advantageously with the aforementioned method.

The center of an enveloping circle of the sections having the thread-forming structure preferably lies outside of the outside diameter of the shaft, whereby the sections come to lie with the largest portion outside of the outside diameter of the shaft. As a result, during the forming of the internal thread, a large portion of the area of these sections is available, thereby largely avoiding stress concentrations and thus damage to the base body material.

The thread-forming structure is preferably provided over the entire outer circumference of the sections projecting beyond the outside diameter of the shaft, thereby guaranteeing an advantageous application of force in the threading tool as well as in the material of the base body. The thread-forming structure preferably runs circularly and ends further advantageously on the outer side of the shaft.

The threading tool is preferably a thread former, which guarantees a simple non-machining formation of the internal thread.

The invention will be explained in more detail in the following on the basis of exemplary embodiments.

### BRIEF DESCRIPTION OF THE DRAWINGS

FIG. 1 is a side view of a first procedural step of the method according to the invention;

FIG. 2 is a side view of a further procedural step of the method according to the invention;

FIG. 3 is a top view of a threading tool;

FIG. 4 is a top view of a base body on which an internal thread is supposed to be formed;

FIG. 5 is a perspective drawing of a tapped bush produced with the method according to the invention; and

FIG. 6 is a partial cross section through the tapped bush according to FIG. 5.

### DETAILED DESCRIPTION OF THE DRAWINGS

As a rule, the same parts are labeled with the same reference numbers in the figures.

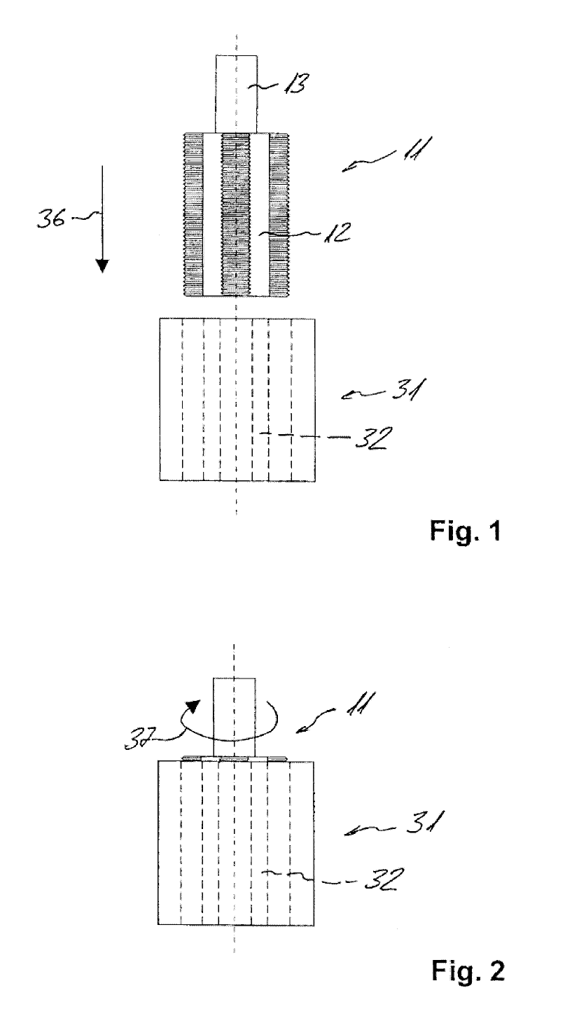

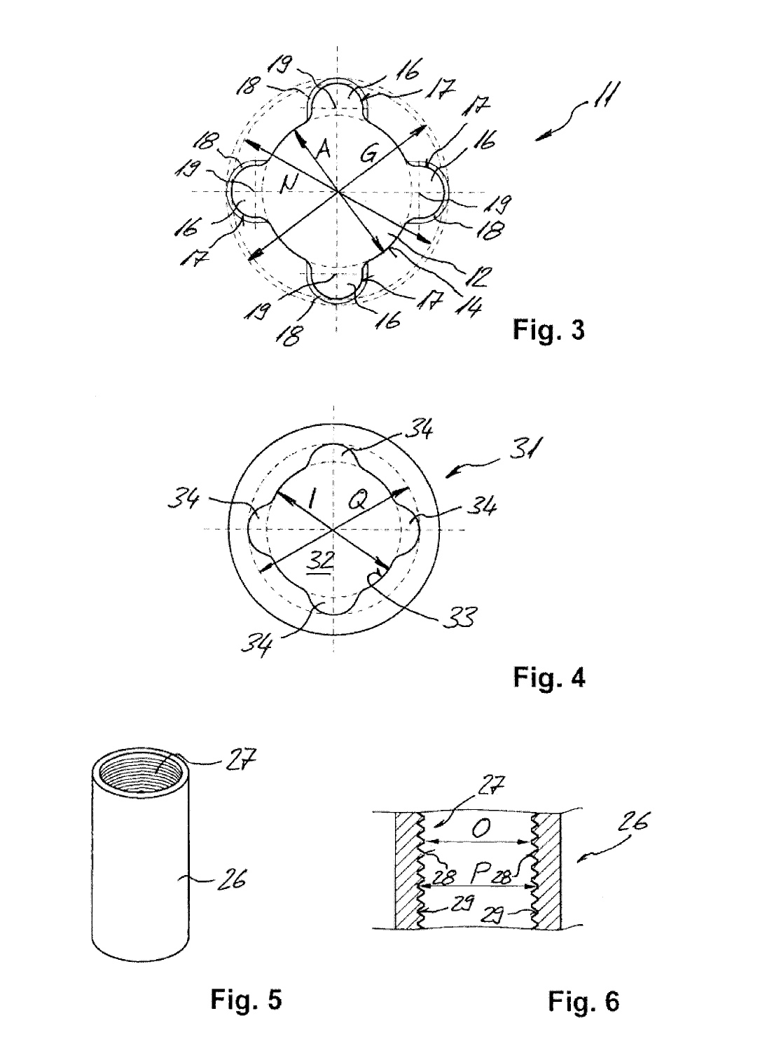

FIGS. 1 and 3 depict a threading tool 11 in the form of a thread former for the non-machining formation of an internal thread on a base body 31. The threading tool 11 features a shaft 12 and insertion end 13 attached to it for arranging the threading tool 11 on a machine (not shown here) for actuating the threading tool 11. The shaft 12 has an outside diameter A as well as a thread-forming device arranged thereon, which is formed by four circumferentially spaced-apart sections 16 arranged in a symmetry of rotation of an integral order. The sections 16 are each offset from one another by 90° on the outer side 14 of the shaft 12.

The sections 16 project beyond the outer side 14 of the shaft 12 defined by the outside diameter A and essentially extend over the entire longitudinal extension or the axial length of the shaft 12. In addition, the sections 16 are provided with thread-cutting structure 18 on their outer side 17 arranged parallel to one another on the sections 16 in the axial direction of the shaft 12. The thread-cutting structure is formed of several elements arranged parallel to each other and in succession in the axial direction of the shaft or of the insertion direction. The thread-forming structure 18 has the negative shape of the to-be-formed threads. The center 19 of an enveloping circle of the sections 16 having the thread-forming structure 18 lies outside of the outside diameter A of the shaft 12. The thread-forming structure 18 extends over the entire outer circumference of the sections 16 projecting beyond the outside diameter A of the shaft 12 and essentially runs circularly in plan view. The thread-forming structure 18 is guided up to the outer side 14 of the shaft 12.

The maximum outside diameter of the threading tool 11 corresponds to the diameter G of the enveloping circle, which surrounds the thread-forming structure 18. The enveloping circle surrounding the sections 16, which feature the thread-forming structure 18, has a diameter that is designated by N.

FIGS. 5 and 6 depict a tapped bush 26 with an internal thread 27 in its interior, which is produced with a previously described threading tool 11. The distance O of opposing thread crests 28 of the internal thread 27 corresponds to the diameter N of the enveloping circle, which surrounds the sections 16 of the threading tool 11, which feature the thread-forming structure 18. The distance P of opposing thread roots 29 of the internal thread 27 corresponds to the diameter G of the enveloping circle surrounding the thread-forming structure 18 or the maximum outside diameter of the threading tool 11.

The base body 31 that is supposed to be provided with an internal thread is depicted in FIG. 4. The base body 31 is bush-shaped and has a continuous opening 32 running over its entire longitudinal extension. The inside diameter I of the opening 32 corresponds to 1.05 to 1.1 times the outside diameter A of the shaft 12 of the threading tool 11.

Four recesses 34 arranged in a symmetry of rotation of an integral order are provided in the inner wall 33 of the base body 31 so that the number of the recesses corresponds to the number of sections 16 having the thread-forming structure 18 on the threading tool 11 and the design of the recesses is coordinated with the design of the sections 16 having the thread-forming structure 18 on the threading tool 11. The greatest distance Q of two recesses 34 corresponds to 1.05 to 1.1 times the maximum outside diameter G of the threading tool 11.

FIGS. 1 and 2 depict the method according to the invention for forming the internal thread 27 on the base body 31. First the threading tool 11 is completely displaced in the direction of the arrow 36 and in the process inserted into the opening 32 in the base body 31 (FIG. 1).

Then, the entire internal thread 27 is formed in the base body 31 by a rotation of the threading tool in the direction of the arrow 37 of 90° (FIG. 2). Afterwards, the threading tool 11 is withdrawn again from the base body 31 in the opposite direction of the arrow 36, thereby producing the tapped bush 26.

Alternatively, the threading tool is embodied as a thread cutter, whereby the internal thread is formed by non-machining in the base body. This type of threading tool advantageously features additional cutting edges along with the thread-forming structure 18.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for forming an internal thread on a base body, comprising the steps of:
inserting a threading tool that includes a section having a thread-forming structure into an opening in the base body; and
forming an entire internal thread in the base body by a maximum rotation of the threading tool of 360°.

2. The method according to claim 1, wherein the threading tool includes several sections having a thread-forming structure arranged in a symmetry of rotation of an integral order and wherein the threading tool is rotated around an angle of rotation which corresponds to a value of a quotient of a full circle divided by a number of sections having the thread-forming structure of the threading tool.

3. The method according to claim 1, wherein the threading tool includes several sections having a thread-forming structure arranged in a symmetry of rotation of an integral order and wherein, prior to the inserting of the threading tool, recesses are arranged in an inner wall of the base body in a symmetry of rotation of an integral order, wherein a number of the recesses corresponds to a number of the sections, and further wherein a design of the recesses is coordinated with a design of the sections.

4. The method according to claim 1, wherein the internal thread is formed by machining in the base body.

5. The method according to claim 1, wherein the internal thread is formed by non-machining in the base body.

6. An apparatus for forming an internal thread on a base body, comprising:
a threading tool with a shaft, which has an outside diameter, and a thread-forming device arranged on the shaft;
wherein the thread-forming device includes at least two circumferentially spaced-apart sections arranged in a symmetry of rotation of an integral order, wherein the sections project beyond the outside diameter of the shaft and include a thread-forming structure on an outer side.

7. The apparatus according to claim 6, wherein a center of an enveloping circle of a respective section lies outside of the outside diameter of the shaft.

8. The apparatus according to claim 6, wherein the thread-forming structure extends over an entire outer circumference of the sections.

9. The apparatus according to claim 6, wherein the threading tool is a thread former.
